(19) United States
(12) Patent Application Publication
(10) Pub. No.: US 2020/0189695 A1
(43) Pub. Date: Jun. 18, 2020

(54) Spar Buoy

(71) Applicant: X Development LLC, Mountain View, CA (US)

(72) Inventor: Charles Joseph Nordstrom, Berkeley, CA (US)

(21) Appl. No.: 16/222,357

(22) Filed: Dec. 17, 2018

(51) Int. Cl. B63B 43/06; B64F 1/12; B64C 39/02; F03D 13/25; B63B 35/44

(52) U.S. Cl. CPC B63B 43/06; B64F 1/12; B64C 39/022; F03D 13/25; F05B 2240/95; B63B 2035/442; F05B 2240/917; F05B 2240/921; B63B 35/44

(57) ABSTRACT

Examples include a spar buoy for use in water, the spar buoy including a bottom section configured to be completely submerged and having a first average diameter, the bottom section including an anchor cable attachment device, a top section configured to be partially submerged, the top section including an aerial tether attachment device, an intermediate section configured to be completely submerged and having a second average diameter that is greater than the first average diameter, where the intermediate section is disposed between the bottom section and the top section, the intermediate section including a buoyancy chamber having a first density less than the water, and a ballast material disposed in the bottom section and having a second density greater than or equal to the water, where the spar buoy is configured to exhibit a particular buoyancy-to-weight ratio and a particular moment ratio when in the water.

### BACKGROUND

Unless otherwise indicated herein, the materials described in this section are not prior art to the claims in this application and are not admitted to be prior art by inclusion in this section.

Power generation systems can convert chemical and/or mechanical energy (e.g., kinetic energy) to electrical energy for various applications, such as utility systems. As one example, a wind energy system can convert kinetic wind energy to electrical energy.

### SUMMARY

A first example includes a spar buoy for use in water, the spar buoy including: a bottom section configured to be completely submerged and having a first average diameter, the bottom section comprising an anchor cable attachment device; a top section configured to be partially submerged, the top section comprising an aerial tether attachment device; an intermediate section configured to be completely submerged and having a second average diameter that is greater than the first average diameter, wherein the intermediate section is disposed between the bottom section and the top section, the intermediate section comprising a buoyancy chamber having a first density less than the water; and a ballast material disposed in the bottom section and having a second density greater than or equal to the water, wherein the spar buoy is configured for a buoyancy-to-weight ratio greater than 1.8 in the water, and wherein the spar buoy is configured for a moment ratio greater than 0.27 in the water.

A second example includes an airborne wind turbine (AWT) including: an aerial vehicle; a spar buoy that is at least partially submerged in water, the spar buoy comprising: a bottom section configured to be completely submerged and having a first average diameter, the bottom section comprising an anchor cable attachment device; a top section configured to be partially submerged, the top section comprising an aerial tether attachment device; an intermediate section configured to be completely submerged and having a second average diameter that is greater than the first average diameter, wherein the intermediate section is disposed between the bottom section and the top section, the intermediate section comprising a buoyancy chamber having a first density less than the water; and a ballast material disposed in the bottom section and having a second density greater than or equal to the water, wherein the spar buoy has a buoyancy-to-weight ratio greater than 1.8, and wherein the spar buoy has a moment ratio greater than 0.27, an anchor cable that anchors the anchor cable attachment device to a seafloor; and a tether that couples the aerial tether attachment device to the aerial vehicle.

A third example includes an airborne wind turbine (AWT) includes: an aerial vehicle; a spar buoy that is at least partially submerged in water, the spar buoy including: a bottom section configured to be completely submerged and having a first average diameter, the bottom section comprising an anchor cable attachment device; a top section configured to be partially submerged, the top section comprising an aerial tether attachment device; an intermediate section configured to be completely submerged and having a second average diameter that is greater than the first average diameter, wherein the intermediate section is disposed between the bottom section and the top section, the intermediate section comprising a buoyancy chamber having a first density less than the water; and a ballast material disposed in the bottom section and having a second density greater than or equal to the water, wherein the spar buoy has a buoyancy-to-weight ratio greater than 1.8, and wherein the spar buoy has a moment ratio greater than 0.27, an anchor cable that anchors the anchor cable attachment device to a seafloor; and a tether that couples the aerial tether attachment device to the aerial vehicle, wherein a center of buoyancy of the spar buoy is separated from a center of gravity of the spar buoy by at least 10% of a total length of the spar buoy, wherein a ratio of the first average diameter to the second average diameter is within a range of 1:1.5 to 1:5, and wherein a tension on the anchor cable due to buoyancy of the spar buoy is greater than any tension on the anchor cable due to a weight of the anchor cable.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a schematic diagram of an airborne wind turbine, according to an example.

FIG. 2 is a schematic diagram of an airborne wind turbine, according to an example.

FIG. 3 is a schematic diagram of an airborne wind turbine, according to an example.

### DETAILED DESCRIPTION

Airborne wind turbines (AWTs) are generally configured to convert kinetic energy of the wind into electrical energy that can be transferred to a power grid or an energy storage system such as a battery or a capacitor bank. An AWT often includes an aerial vehicle that is tethered via a conductive tether to a fixed ground station. In some applications, such as those described in this disclosure, the aerial vehicle is tethered to a buoy (e.g., a spar buoy) that floats at sea and is anchored to the seafloor via an anchor cable.

Operation typically begins with the aerial vehicle drawing electrical power via the tether from the spar buoy (e.g., from a power grid or battery connected to the spar buoy) such that the aerial vehicle uses its onboard actuators (e.g., dual purpose propellor/generators) to take off from or near the spar buoy. Next, the aerial vehicle can engage in hover flight such that the aerial vehicle positions itself at an attitude, altitude, and a position (e.g., downwind from the spar buoy) that is suitable for crosswind flight. The aerial vehicle then uses its actuators to transition itself from hover flight into crosswind flight, during which the actuators switch to a power generation mode. That is, the wind and the tether that binds the aerial vehicle to the spar buoy interact such that the aerial vehicle makes substantially circular revolutions about an axis that is substantially parallel with the wind flow direction. During crosswind flight, air resistance causes the actuators to generate electric energy that is transmitted through the tether to the spar buoy (e.g., to a power grid). Depending on wind conditions or sea conditions, it can be challenging to keep at least part of the spar buoy and the aerial vehicle above the water during severe sway movement. To this end, this disclosure describes a spar buoy that has improved buoyancy properties.

Within examples, a spar buoy includes a bottom section configured to be completely submerged and having a first average diameter. The bottom section includes an anchor cable attachment device for use in anchoring the spar buoy to a seafloor. The spar buoy also includes a top section configured to be partially submerged. The top section includes an aerial tether attachment device for use in attaching the spar buoy to a tether which binds an aerial vehicle to the spar buoy. The spar buoy also includes an intermediate section configured to be completely submerged and having a second average diameter that is greater than the first average diameter of the bottom section. The intermediate section is disposed between the bottom section and the top section. The intermediate section includes a buoyancy chamber having a first density less than the water. The spar buoy also includes a ballast material (e.g., sand, metal, etc.) disposed in the bottom section and having a second density greater than or equal to the water. The relative positions of the buoyancy chamber and the ballast material can create a separation between a center of buoyancy for the spar buoy and a center of gravity for the spar buoy. This separation can be useful as described below.

Thus, the spar buoy is configured for a buoyancy-to-weight ratio greater than 1.8 (e.g., greater than 2.0 or 2.2) in the water and configured for a moment ratio greater than 0.27 (e.g., greater than 0.3 or 0.33) in the water. That is, during operation in the water, the spar buoy can experience a total buoyancy force that is at least 1.8 times the total weight of the spar buoy (e.g., the total weight including a weight of an anchor cable but not of an anchor). Similarly, during operation in the water, the spar buoy is configured to experience three torque moments: a first moment resulting from a horizontal force applied by the tether (e.g., by the aerial vehicle), from waves within the water, and/or from the wind, a second moment resulting from a vertical gravitational force due to the spar buoy's weight, and a third moment resulting from the buoyancy of the spar buoy. The spar buoy is configured such that, during operation in the water, the sum of the second moment and the third moment can be at least 0.27 times the first moment. The first moment is typically dependent on a maximum average horizontal tether tension expected to be applied by the aerial vehicle during crosswind flight. These enhanced buoyancy properties make it less likely that the entire spar buoy and/or the aerial vehicle will become submerged during operation or at rest. The enhanced buoyancy properties are at least partially the result of the second average diameter of the intermediate section being larger than the first average diameter of the bottom section and creating a separation between the center of gravity and the center of buoyancy.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

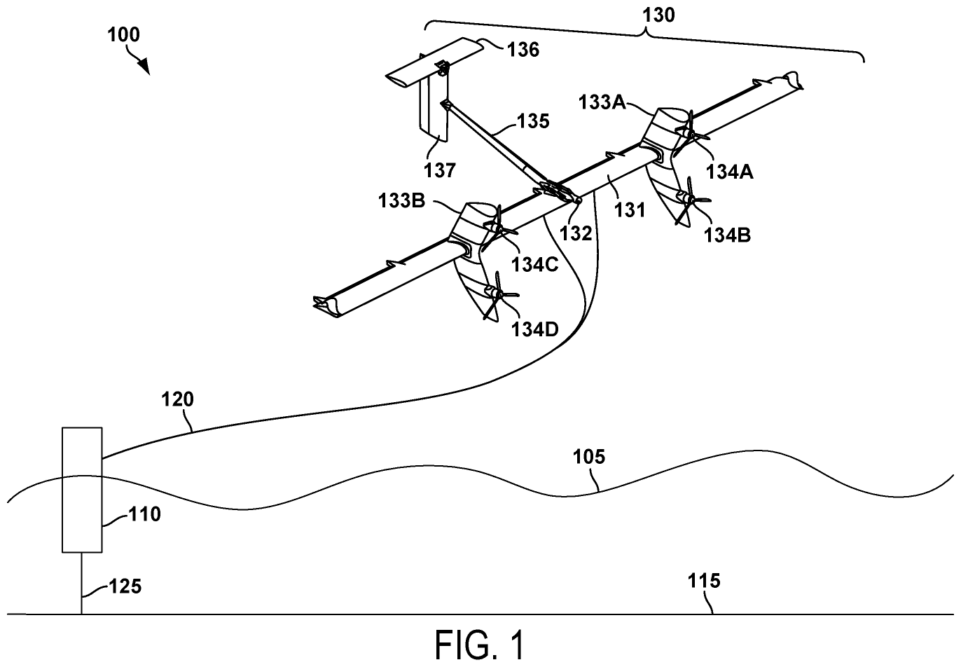

Referring now to the figures, FIG. 1 depicts an airborne wind turbine 100, according to an example. The airborne wind turbine 100 includes a spar buoy 110, a tether 120, an aerial vehicle 130, and an anchor cable 125.

The aerial vehicle 130 is connected to the tether 120, and the tether 120 is connected to the spar buoy 110. As depicted, the tether 120 is attached to the spar buoy 110 at one location on the spar buoy 110, and attached to the aerial vehicle 130 at two locations on the aerial vehicle 130. However, in other examples, the tether 120 is attached at multiple locations to any part of the spar buoy 110 or the aerial vehicle 130. The spar buoy 110 is connected to a seafloor 115 via the anchor cable 125 (e.g., a chain, cable, or a twisted or woven strand of flexible fabric) and is buoyant in water 105 (e.g., the sea, a lake, etc).

In one embodiment, the spar buoy 110 can be used to hold or support the aerial vehicle 130 until the aerial vehicle 130 is in a flight mode. Further, the spar buoy 110 is configured to receive the aerial vehicle 130 during a landing. That is, the aerial vehicle 130 can perch upon the spar buoy 110 and the spar buoy 110 will float and generally keep the aerial vehicle 130 above the water 105.

The spar buoy 110 can include one or more components (not shown), such as a winch, that can vary a length of the tether 120. For example, when the aerial vehicle 130 is deployed, the one or more components can be configured to pay out or reel out the tether 120. In some implementations, the one or more components can be configured to pay out or reel out the tether 120 to a predetermined length. As examples, the predetermined length could be equal to or less than a maximum length of the tether 120. Further, when the aerial vehicle 130 lands on the spar buoy 110, the one or more components can be configured to reel in the tether 120.

The tether 120 can transmit electrical energy generated by the aerial vehicle 130 to the spar buoy 110. In addition, the tether 120 can transmit electricity to the aerial vehicle 130 from a power grid (not shown) connected to the spar buoy 110 to power the aerial vehicle 130 for takeoff, landing, hover flight, or forward flight. The tether 120 can be constructed in any form and using any material which allows for the transmission, delivery, or harnessing of electrical energy generated by the aerial vehicle 130 or transmission of electricity to the aerial vehicle 130. The tether 120 is typically waterproof. The tether 120 can also be configured to withstand one or more forces of the aerial vehicle 130 when the aerial vehicle 130 is in a flight mode. For example, the tether 120 can include a core configured to withstand one or more forces of the aerial vehicle 130 when the aerial vehicle 130 is in hover flight, forward flight, or crosswind flight. The core can be constructed of high strength fibers. In some examples, the tether 120 can have a fixed length or a variable length.

The aerial vehicle 130 can include various types of devices, such as a kite, a helicopter, a wing, or an airplane, among other possibilities. The aerial vehicle 130 can be formed of solid structures of metal, plastic, polymers, or any material which allows for a high thrust-to-weight ratio and generation of electrical energy which can be used in utility applications. Additionally, the materials can allow for a lightning hardened, redundant or fault tolerant design which can be capable of handling large or sudden shifts in wind speed and wind direction. Other materials may be possible as well.

As shown in FIG. 1, the aerial vehicle 130 includes a main wing 131, a front section 132, pylons 133A-B, actuators 134A-D, a fuselage 135, a tail wing 136, and a vertical stabilizer 137. Any of these components can be shaped in any form which allows for the use of lift to resist gravity and/or move the aerial vehicle 130 forward.

The main wing 131 can provide a primary lift for the aerial vehicle 130 during forward flight, wherein the aerial vehicle 130 can move through air in a direction substantially parallel to a direction of thrust provided by the actuators 134A-D so that the main wing 131 provides a lift force substantially perpendicular to a ground. The main wing 131 can be one or more rigid or flexible airfoils, and can include various control surfaces or actuators, such as winglets, flaps, rudders, elevators, etc. The control surfaces can be used to steer or stabilize the aerial vehicle 130 or reduce drag on the aerial vehicle 130 during hover flight, forward flight, or crosswind flight. The main wing 131 can be any suitable material for the aerial vehicle 130 to engage in hover flight, forward flight, or crosswind flight. For example, the main wing 131 can include carbon fiber or e-glass. Moreover, the main wing 131 can have a variety dimensions. For example, the main wing 131 can have one or more dimensions that correspond with a conventional wind turbine blade. The front section 132 can include one or more components, such as a nose, to reduce drag on the aerial vehicle 130 during flight.

The pylons 133A-B can connect the actuators 134A-D to the main wing 131. In the example depicted in FIG. 1, the pylons 133A-B are arranged such that the actuators 134A and 134B are located on opposite sides of the main wing 131 and actuators 134C and 134D are also located on opposite sides of the main wing 131. The actuator 134C can also be located on an end of the main wing 131 opposite of the actuator 134A, and the actuator 134D can be located on an end of main wing 131 opposite of the actuator 134B.

In a power generating mode, the actuators 134A-D can be configured to drive one or more generators for the purpose of generating electrical energy. As shown in FIG. 1, the actuators 134A-D can each include one or more blades. The actuator blades can rotate via interactions with the wind and could be used to drive the one or more generators. In addition, the actuators 134A-D can also be configured to provide a thrust to the aerial vehicle 130 during flight. As shown in FIG. 1, the actuators 134A-D can function as one or more propulsion units, such as a propeller. Although the actuators 134A-D are depicted as four actuators in FIG. 1, in other examples the aerial vehicle 130 can include any number of actuators.

In a forward flight mode, the actuators 134A-D can be configured to generate a forward thrust substantially parallel to the fuselage 135. Based on the position of the actuators 134A-D relative to the main wing 131 depicted in FIG. 1, the actuators can be configured to provide a maximum forward thrust for the aerial vehicle 130 when all of the actuators 134A-D are operating at full power. The actuators 134A-D can provide equal or about equal amounts of forward thrusts when the actuators 134A-D are operating at full power, and a net rotational force applied to the aerial vehicle by the actuators 134A-D can be zero.

The fuselage 135 can connect the main wing 131 to the tail wing 136 and the vertical stabilizer 137. The fuselage 135 can have a variety of dimensions. In such implementations, the fuselage 135 can carry a payload.

The tail wing 136 or the vertical stabilizer 137 can be used to steer or stabilize the aerial vehicle 130 or reduce drag on the aerial vehicle 130 during hover flight, forward flight, or crosswind flight. For example, the tail wing 136 or the vertical stabilizer 137 can be used to maintain a pitch or a yaw attitude of the aerial vehicle 130 during hover flight, forward flight, or crosswind flight. In FIG. 1, the vertical stabilizer 137 is attached to the fuselage 135, and the tail wing 136 is located on top of the vertical stabilizer 137. The tail wing 136 can have a variety of dimensions.

While the aerial vehicle 130 has been described above, it should be understood that the methods and systems described herein could involve any aerial vehicle that is connected to a tether, such as the tether 120.

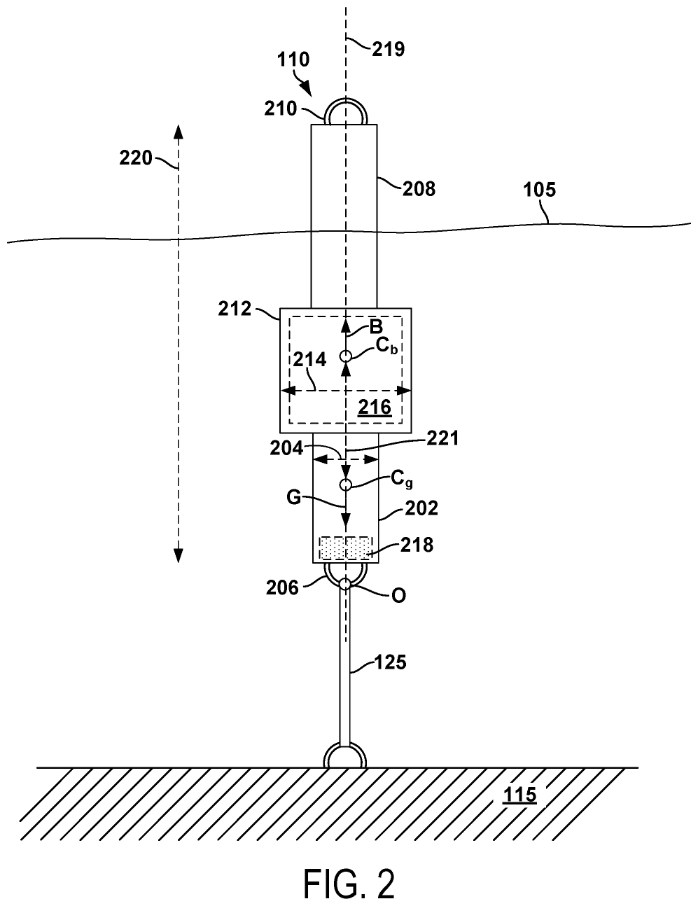

FIG. 2 shows a more detailed view of the spar buoy 110. In FIG. 2, the spar buoy 110 is substantially upright and the tether 120 and the aerial vehicle 130 are omitted for clarity. The spar buoy 110 being substantially upright could be the result of calm seas (e.g., the water 105 lacking substantial waves) and/or the aerial vehicle 130 not being in operation and therefore not exerting a substantial force on an aerial tether attachment device 210.

As noted above, the spar buoy 110 includes a bottom section 202 configured to be completely submerged in the water 105. The bottom section 202 could take the form of a foam casing or other materials that are typically buoyant in water. In other examples, the bottom section 202 could take the form of a steel or composite tube. The bottom section 202 has a first average diameter 204. The bottom section 202 is shown having a constant diameter, but in other examples, the first average diameter can be an average of a diameter of the bottom section that varies with respect to longitudinal position (e.g., up and down with respect to FIG. 2). Herein, the term “diameter” can refer to any straight line passing from side to side through a center of the bottom section 202 (e.g., left to right or vice versa with respect to FIG. 2). The bottom section 202 could have a cross section taking the form of a circle, an ellipse, or a hexagon, for example. Additionally, the bottom section 202 could take the form of a sphere, a cylinder, a tapered cylinder, or a hexagonal prism, among other examples.

The bottom section 202 also includes the anchor cable attachment device 206 which can take the form of a circular metal ring, among other forms. In FIG. 2, the anchor cable attachment device 206 is anchored to the seafloor 115 via the anchor cable 125. A tension on the anchor cable 125 due to buoyancy of the spar buoy 110 is generally (e.g., much) greater than any tension on the anchor cable 125 due to a weight of the anchor cable 125.

The spar buoy 110 also includes a top section 208 configured to be partially submerged in the water 105. The top section 208 includes the aerial tether attachment device 210, which can be similar to the anchor cable attachment device 206. The top section 208 could take the form of a foam casing, a steel or composite tube, or other materials that are typically buoyant in water.

The spar buoy 110 also includes an intermediate section 212 configured to be completely submerged in the water 105 and having a second average diameter 214 that is greater than the first average diameter 204. The intermediate section 212 could take the form of a foam casing, a steel or composite tube, or other materials that are typically buoyant in water. The intermediate section 212 is shown having a constant diameter, but in other examples, the second average diameter can be an average of a diameter of the intermediate section that varies with respect to longitudinal position (e.g., up and down with respect to FIG. 2). Herein, the term “diameter” can refer to any straight line passing from side to side through a center of the intermediate section 212 (e.g., left to right or vice versa with respect to FIG. 2). The intermediate section 212 could have a cross section taking the form of a circle, an ellipse, or a hexagon, for example. Additionally, the intermediate section 212 could take the form of a sphere, a cylinder, a tapered cylinder, or a hexagonal prism, among other examples.

The intermediate section 212 is disposed between the bottom section 202 and the top section 208. The intermediate section 212 includes a buoyancy chamber 216 having a first density less than the water 105. The buoyancy chamber 216 could be filled with foam, air, or a combination thereof, for example.

The spar buoy 110 includes a ballast material 218 such as sand or metal disposed in the bottom section 202 and having a second density greater than or equal to the water 105. As shown in FIG. 2, the ballast material 218 could be disposed at a bottom end of the bottom section 202.

A center of buoyancy C_{b} of the spar buoy 110 could be separated from a center of gravity C_{g} of the spar buoy 110 by at least 10% of a total length 220 of the spar buoy 110. The total length 220 could be within a range of 30 meters to 70 meters.

Additionally or alternatively, the center of buoyancy C_{b} could be separated from the center of gravity C_{g} along a long axis 219 of the spar buoy 110 by at least 3 meters, as indicated in FIG. 2 by length 221.

Additionally or alternatively, a ratio of the first average diameter 204 to the second average diameter 214 is within a range of 1:1.5 to 1:5.

As such, the spar buoy can be configured for a buoyancy-to-weight ratio greater than 1.8, 2.0, or 2.2 in the water.

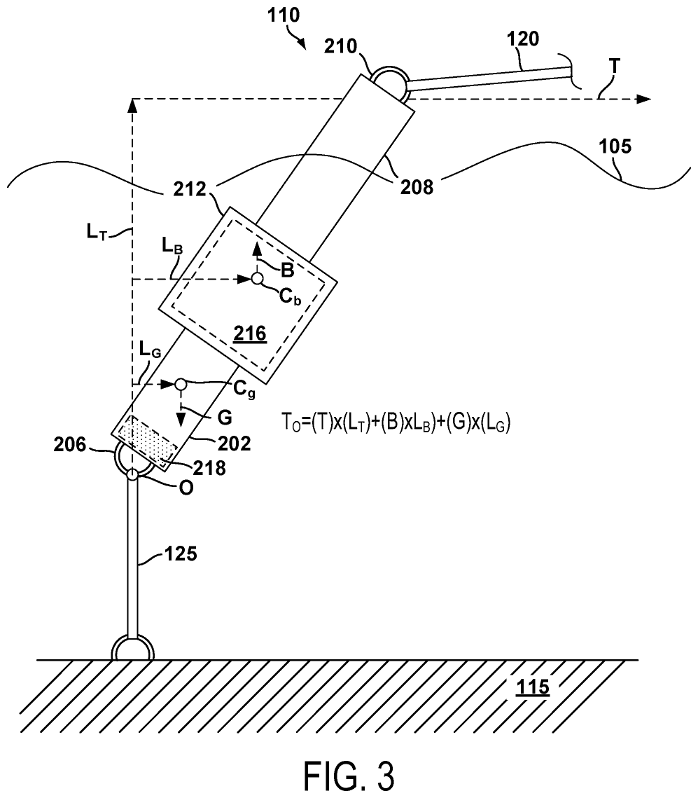

FIG. 3 shows the spar buoy 110 in a pitched state, which can be the result of waves in the water 105 (e.g., moving rightward), tension T applied to the spar buoy 110 by the aerial vehicle 130 via the tether 120, and/or the wind. In FIG. 3, T_{O} is a total torque moment about the point O. L_{T} is a total vertical distance between the aerial tether attachment device 210 and the point O. B is a (vertical) total buoyancy force acting on the center of buoyancy C_{b}. L_{B} is a total horizontal distance between the point O and the center of buoyancy C_{b}. G is a (vertical) total gravitational force acting on the center of gravity C_{g}. L_{G} is a total horizontal distance between the point O and the center of gravity C_{g}. A torque moment T_{O} is defined by the following equation (1) where “x” denotes a cross product operator:

T_{O}=(T)×(L_{T})+(B)×(L_{B})+(G)×(L_{G}) (1)

Thus, the spar buoy 110 is configured for a buoyancy-to-weight ratio greater than 1.8 (e.g., greater than 2.0 or 2.2) in the water 105 and configured for a moment ratio greater than 0.27 (e.g., greater than 0.3 or 0.33) in the water 105. That is, during operation in the water 105, the spar buoy 110 can experience a total buoyancy force B that is at least 1.8 times the total weight G of the spar buoy 110 (e.g., the total weight including a weight of the anchor cable 125 but not of an anchor). Similarly, during operation in the water 105, the spar buoy 110 is configured to experience three torque moments: a first moment TL_{T} resulting from a horizontal force T applied by the tether 120 (e.g., by the aerial vehicle 130), from waves within the water 105, and/or from the wind, a second moment GL_{G} resulting from a vertical gravitational force due to the weight of the spar buoy 110, and a third moment −BL_{B} resulting from the buoyancy of the spar buoy 110. The spar buoy 110 is configured such that, during operation in the water 105, the sum of the second moment GL_{G} and the third moment −BL_{B} can be at least 0.27 times the first moment. The spar buoy 110 can be configured with T typically equal to a maximum average horizontal tether tension expected to be applied by the aerial vehicle 130 during crosswind flight. These enhanced buoyancy properties make it less likely that the entire spar buoy 110 and/or the aerial vehicle 130 will become submerged during operation or at rest. The enhanced buoyancy properties are at least partially the result of the second average diameter 216 of the intermediate section 212 being larger than the first average diameter 204 of the bottom section 202.

Thus, a minimum distance between the center of buoyancy C_{b} of the spar buoy 110 and the center of gravity C_{g} of the spar buoy 110 allow the spar buoy 110 to exhibit enhanced self-restorative characteristics.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A spar buoy for use in water, the spar buoy comprising:
a bottom section configured to be completely submerged and having a first average diameter, the bottom section comprising an anchor cable attachment device;
a top section configured to be partially submerged, the top section comprising an aerial tether attachment device;
an intermediate section configured to be completely submerged and having a second average diameter that is greater than the first average diameter, wherein the intermediate section is disposed between the bottom section and the top section, the intermediate section comprising a buoyancy chamber having a first density less than the water; and
a ballast material disposed in the bottom section and having a second density greater than or equal to the water,
wherein the spar buoy is configured for a buoyancy-to-weight ratio greater than 1.8 in the water, and
wherein the spar buoy is configured for a moment ratio greater than 0.27 in the water.

2. The spar buoy of claim 1, wherein a center of buoyancy of the spar buoy is separated from a center of gravity of the spar buoy by at least 10 percent of a total length of the spar buoy.

3. The spar buoy of claim 1, wherein a center of buoyancy of the spar buoy is separated from a center of gravity of the spar buoy by at least 3 meters.

4. The spar buoy of claim 1, wherein a total length of the spar buoy is within a range of 30 meters to 70 meters.

5. The spar buoy of claim 1, wherein a ratio of the first average diameter to the second average diameter is within a range of 1:1.5 to 1:5.

6. The spar buoy of claim 1, wherein the buoyancy-to-weight ratio is greater than 2.

7. The spar buoy of claim 1, wherein the buoyancy-to-weight ratio is greater than 2.2.

8. The spar buoy of claim 1, wherein the moment ratio is greater than 0.3.

9. The spar buoy of claim 1, wherein the moment ratio is greater than 0.33.

10. The spar buoy of claim 1, wherein when the anchor cable attachment device is anchored to a seafloor via an anchor cable, wherein a tension on the anchor cable due to buoyancy of the spar buoy is greater than any tension on the anchor cable due to a weight of the anchor cable.

11. An airborne wind turbine (AWT) comprising:
an aerial vehicle;
a spar buoy that is at least partially submerged in water, the spar buoy comprising:
a bottom section configured to be completely submerged and having a first average diameter, the bottom section comprising an anchor cable attachment device;
a top section configured to be partially submerged, the top section comprising an aerial tether attachment device;
an intermediate section configured to be completely submerged and having a second average diameter that is greater than the first average diameter, wherein the intermediate section is disposed between the bottom section and the top section, the intermediate section comprising a buoyancy chamber having a first density less than the water; and
a ballast material disposed in the bottom section and having a second density greater than or equal to the water,
wherein the spar buoy has a buoyancy-to-weight ratio greater than 1.8, and
wherein the spar buoy has a moment ratio greater than 0.27,
an anchor cable that anchors the anchor cable attachment device to a seafloor; and
a tether that couples the aerial tether attachment device to the aerial vehicle.

12. The AWT of claim 11, wherein a center of buoyancy of the spar buoy is separated from a center of gravity of the spar buoy by at least 10 percent of a total length of the spar buoy.

13. The AWT of claim 11, wherein a center of buoyancy of the spar buoy is separated from a center of gravity of the spar buoy by at least 3 meters.

14. The AWT of claim 11, wherein a ratio of the first average diameter to the second average diameter is within a range of 1:1.5 to 1:5.

15. The AWT of claim 11, wherein the buoyancy-to-weight ratio is greater than 2.

16. The AWT of claim 11, wherein the buoyancy-to-weight ratio is greater than 2.2.

17. The AWT of claim 11, wherein the moment ratio is greater than 0.3.

18. The AWT of claim 11, wherein the moment ratio is greater than 0.33.

19. The AWT of claim 11, wherein a tension on the anchor cable due to buoyancy of the spar buoy is greater than any tension on the anchor cable due to a weight of the anchor cable.

20. An airborne wind turbine (AWT) comprising:
an aerial vehicle;
a spar buoy that is at least partially submerged in water, the spar buoy comprising:
a bottom section configured to be completely submerged and having a first average diameter, the bottom section comprising an anchor cable attachment device;
a top section configured to be partially submerged, the top section comprising an aerial tether attachment device;
an intermediate section configured to be completely submerged and having a second average diameter that is greater than the first average diameter, wherein the intermediate section is disposed between the bottom section and the top section, the intermediate section comprising a buoyancy chamber having a first density less than the water; and
a ballast material disposed in the bottom section and having a second density greater than or equal to the water,
wherein the spar buoy has a buoyancy-to-weight ratio greater than 1.8, and
wherein the spar buoy has a moment ratio greater than 0.27,
an anchor cable that anchors the anchor cable attachment device to a seafloor; and
a tether that couples the aerial tether attachment device to the aerial vehicle,
wherein a center of buoyancy of the spar buoy is separated from a center of gravity of the spar buoy by at least 10 percent of a total length of the spar buoy,
wherein a ratio of the first average diameter to the second average diameter is within a range of 1:1.5 to 1:5, and
wherein a tension on the anchor cable due to buoyancy of the spar buoy is greater than any tension on the anchor cable due to a weight of the anchor cable.
